(19) United States
(12) Patent Application Publication
(10) Pub. No.: US 2013/0283293 A1
(43) Pub. Date: Oct. 24, 2013

(54) System and method for Intelligently distributing a plurality of transactions for parallel processing

(71) Applicants: Bo Jonas Lagerblad, Palo Alto, CA (US); Asquith A. Bailey, Palo Alto, CA (US); Arun L. Katkere, Los Gatos, CA (US); Sitaram Krishnamurthy Iyer, Sunnyvale, CA (US)

(72) Inventors: Bo Jonas Lagerblad, Palo Alto, CA (US); Asquith A. Bailey, Palo Alto, CA (US); Arun L. Katkere, Los Gatos, CA (US); Sitaram Krishnamurthy Iyer, Sunnyvale, CA (US)

(73) Assignee: TIBCO SOFTWARE INC., Palo Alto, CA (US)

(21) Appl. No.: 13/452,644

(22) Filed: Apr. 20, 2012

(51) Int. Cl. G06F 9/54

(52) U.S. Cl. 719/314

(57) ABSTRACT

Disclosed are systems and methods for distributing a plurality of transactions for parallel processing, which includes receiving a message, such that each transaction comprises information associated with a target object, wherein the target object is stored in a memory. The systems and methods further include parsing the messages into the plurality of transactions, transmitting the parsed transactions to a transaction queue, receiving a transaction from the transaction queue, determining the target object associated with the transaction, assigning the transaction to a particular processing queue based on the target object, and guaranteeing that subsequent transactions associated with the target object are assigned to the same processing queue and the same processor, which guarantees that the target object will be modified in correct sequence.

### TECHNICAL FIELD

This disclosure generally relates to parallel processing and, more particularly, relates to intelligently distributing a plurality of transactions for parallel processing.

### BACKGROUND

Typical parallel processing environments do not ensure that objects are modified or updated in the correct order. Rather, a first received event that modifies a particular object in memory may be processed prior to a second received event that modifies the same object in memory, which is one of the risks taken to gain the benefits of parallel processing. In certain situations, the order of updating or modifying an object based on the order of the events received is important. The need has arisen to provide a mechanism for processing multiple transactions in parallel while ensuring that transactions modifying the same object are processed in serial to preserve the order of events.

### SUMMARY

Disclosed are embodiments of systems and methods for distributing a plurality of transactions for parallel processing, which includes receiving a message, wherein the message comprises a plurality of transactions, such that each transaction comprises information associated with a target object, wherein the target object is stored in a memory. The systems and methods further include parsing the messages into the plurality of transactions, transmitting the parsed transactions to a transaction queue, receiving a transaction from the transaction queue, determining the target object associated with the transaction, assigning the transaction to a particular processing queue based on the target object, wherein the particular processing queue is associated with a particular processor, and guaranteeing that subsequent transactions associated with the target object are assigned to the same processing queue and the same processor, which guarantees that the target object will be modified in correct sequence, wherein the transaction associated with the target object is processed in parallel with other transactions associated with different target objects.

Also disclosed are embodiments of systems and methods for receiving a subsequent transaction from the transaction queue, determining that a second target object is associated with the subsequent transaction, assigning the subsequent transaction to a second processing queue based on the second target object being different than the first target object, and guaranteeing that additional subsequent transactions associated with the second target object are assigned to the second processing queue and the second processor, which guarantees that the second target object will be modified in correct sequence, wherein the transaction associated with the second object is processed by the second processor in parallel with the transaction associated with the target object processed by the first processor.

The present disclosure provides several important technical advantages. In certain embodiments, the present disclosure provides mechanisms for providing a high degree of scalability using parallel processing with little to no risk of memory or database collisions by guaranteeing the order that the targeted objects are modified or updated from the processing. By using the same thread or processor to process transactions that modify the same target object in serial, it eliminates the risks and errors caused when multiple threads or processors are used to process transactions modifying the same target object in parallel. Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

Embodiments are illustrated by way of example in the accompanying figures, in which like reference numbers indicate similar parts, and in which:

FIG. 1 is a schematic diagram illustrating an example system for distributing a plurality of transactions for parallel processing, in accordance with the present disclosure;

FIG. 2 is a flow diagram illustrating a process for distributing a plurality of transactions for parallel processing, in accordance with the present disclosure;

FIG. 3 is a schematic diagram illustrating another example system for distributing a plurality of transactions for parallel processing, in accordance with the present disclosure; and

FIG. 4 is a flow diagram illustrating another process for distributing a plurality of transactions for parallel processing, in accordance with the present disclosure.

### DETAILED DESCRIPTION

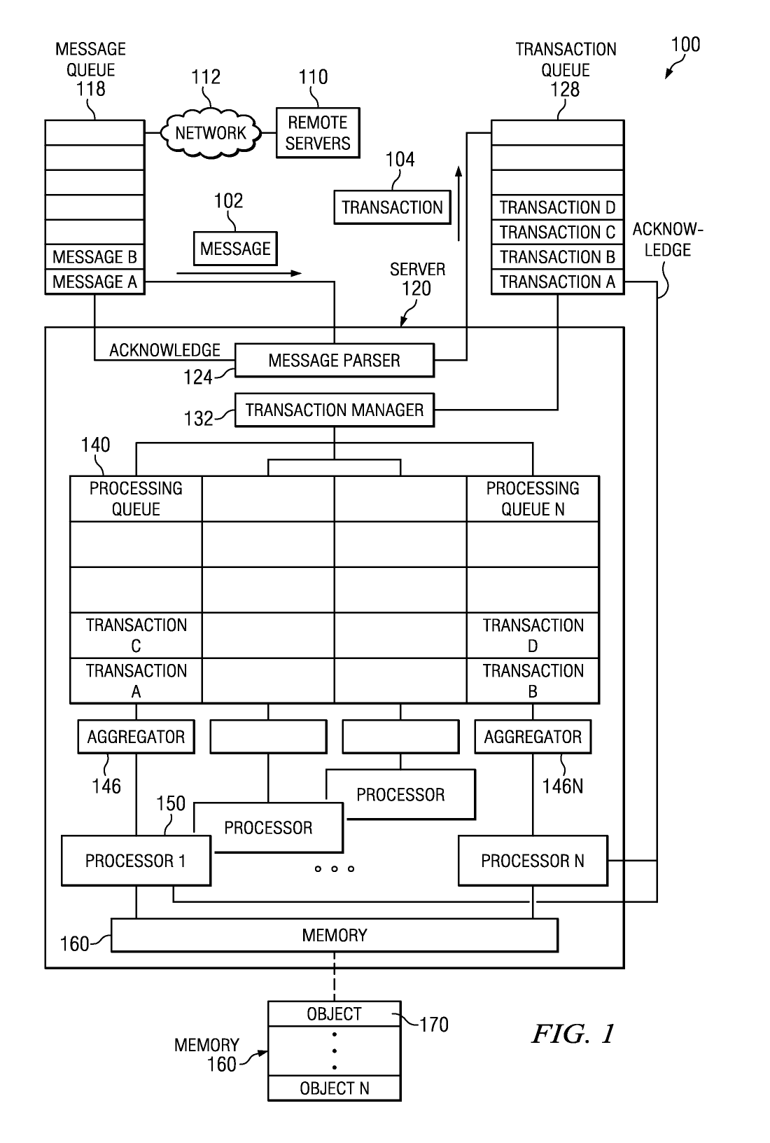

FIG. 1 is a schematic diagram illustrating an example system 100 distributing a plurality of transactions for parallel processing, in accordance with the present disclosure. According to the illustrated embodiment, system 100 may include a server 120 comprising a message queue 118, a message parser 124, a transaction manager 132, a transaction queue 128, a transaction manager 132, one or more processing queues 140-140n, one or more processors 150-150n, and a memory 160. Messages 102 may originate from remote servers 110 via network 112 and be received at message queue 118. Each message 102 may include one or more sub-events or transactions 104 that may be processed by one of the processors 150 to modify or update an object 170 stored in memory 160. System 100 may process multiple transactions 104 in parallel while ensuring that transactions 104, which are associated with modifying the same object 170, are processed in serial to ensure that each object 170 is modified in the proper order. Thus, system 100 gains the benefits of modifying multiple objects 170 in memory 160 simultaneously while eliminating the risks that an object 170 may be modified by a transaction 104 out of order.

As used herein, messages 102 refer to any type of data that may be processed to modify, update, or store one or more values or objects 170 in memory 160. Messages 102 may be communicated in any form. Messages 102 may include one or more sub-events or transactions 104. Each transaction 104 refers to any type of data that may be processed to modify, update, or store a value or object 170 in memory 160. Transactions 104 may include software, computer instructions, and/or logic that may be processed by processors 150. For example, an electronic message 102 to transfer money from a first account to a second account may include a first transaction 104 to subtract the money from the first account and a second transaction 104 to add the money to the second account.

Remote servers 110 may represent a general or special-purpose computer capable of performing the described operations. For example, remote servers 110 may include, but are not limited to, mobile devices; cell phones; laptop computers; desktop computers; end user devices; video monitors; cameras; personal digital assistants (PDAs); or any other communication hardware, software, and/or encoded logic that supports the communication of messages 102, transactions 104, texts, or other suitable forms of data. Remote servers 110 may include any appropriate combination of hardware, software, memory, and/or encoded logic suitable to perform the described functionality. System 100 may comprise any appropriate number and type of remote servers 110. Although the embodiment illustrated in FIG. 1 illustrates that remote servers 110 may be external to server 120, remote servers 110 may be integral or directly connected to server 120.

Network 112 may represent any form of communication network supporting circuit-switched, packet-based, and/or any other suitable type of communications between remote servers 110, server 120, and any other elements illustrated in FIG. 1. Network 112 may additionally include any other nodes of system 100 capable of transmitting and/or receiving information over a communication network. Although shown in FIG. 1 as a single element, network 112 may represent one or more separate networks (including all or parts of various different networks) that are separated and serve different respective elements illustrated in FIG. 1. Network 112 may include routers, hubs, switches, firewalls, content switches, gateways, call controllers, and/or any other suitable components in any suitable form or arrangement. Network 112 may include, in whole or in part, one or more secured and/or encrypted Virtual Private Networks (VPNs) operable to couple one or more network elements together by operating or communicating over elements of a public or external communication network. In general, network 112 may comprise any combination of public or private communication equipment such as elements of the public switched telephone network (PSTN), a global computer network such as the Internet, a local area network (LAN), a wide area network (WAN), or other appropriate communication equipment. In some embodiments, remote servers 110 and server 120 may exist on the same machine, which may obviate the need for any network communications.

Message queue 118 may be any type of storage or buffer implementation to receive messages 102 from remote servers 110. In some embodiments, message queue 118 may implement a first-in-first-out queue though any type of queue may be used to perform the described functionality. Although the embodiment illustrated in FIG. 1 illustrates message queue 118 may be external to server 120, message queue 118 may be stored on server 120.

Server 120 represents any appropriate combination of hardware, memory, logic, and/or software suitable to perform the described functions. For example, server 120 may be any suitable computing device comprising a processor and a memory. Server 120 may comprise one or more machines, workstations, laptops, blade servers, server farms, and/or stand-alone servers. Server 120 may be operable to communicate with any node or component in system 100 in any suitable manner.

Message parser 124 represents any appropriate combination of hardware, memory, logic, and/or software suitable to perform the described functions. Message parser 124 may receive message 102 via message queue 118 and parse message 102 into one or more transactions 104. Message parser 124 may intelligently identify different sub-events or transactions 104 in message 102 based on any type of criteria, including, but not limited to properties associated with message 102, the type of instruction included in message 102, the type of message 102, the object 170 modified by an instruction, etc. Message parser 124 may transmit each parsed transaction 104 of message 102 to transaction queue 128, and communicate an acknowledge signal to message queue 118 to remove the parsed message 102 from message queue 118.

Transaction queue 128 may be any type of storage or buffer implementation to receive transactions 104 from message parser 124. In some embodiments, transaction queue 128 may implement a first-in-first-out queue though any type of queue may be used to perform the described functionality. Although the embodiment illustrated in FIG. 1 illustrates that transaction queue 128 may be external to server 120, transaction queue 128 may be stored on server 120.

Transaction manager 132 represents any appropriate combination of hardware, memory, logic, and/or software suitable to perform the described functions. Transaction manager 132 may receive one or more transactions 104 via transaction queue 128. Transaction manager 132 may intelligently identify which processing queue 140 and processor 150 should receive each particular transaction 104 based on any type of criteria, including, but not limited to properties associated with transaction 104, the type of instruction included in the transaction 104, the type of transaction 104, the target object 170 modified by transaction 104, etc. Thus, transaction manager 132 may be able to determine an affinity for certain transactions 104 that should be processed in serial by a particular processor 150. In some embodiments, transaction manager 132 may ensure that a transaction 104 and subsequent transactions 104 that modify or update the same target object 170 are assigned to the same processing queue 140 associated with the same processor 150, which guarantees that the target object 170 be modified or updated in the correct order, while other processors 150 may process other transactions 104 in parallel that modify or update a different target object 170. In some embodiments, all transactions 104 associated with a particular row in a database may be assigned to the same processing queue 140. In some embodiments, transaction manager 132 may determine that all computations for one or more transactions 104 be assigned to a particular processing queue 140 and processed by its respective processor 150 while all other processing queues 140 and processors 150 are blocked from processing any other transactions 104. In some embodiments, transaction manager 132 may determine to use one or more processing queues 140 and processors 150 in a synchronized order. In some embodiments, transaction manager 132 may instruct all transactions 104 within processing queues 140 to be processed and to block all subsequent transactions 104 from being placed in processing queues 140 so that maintenance may be performed.

Processing queue 140-140n may be any type of storage or buffer implementation to receive transactions 104 from transaction manager 132. In some embodiments, processing queue 140 may implement a first-in-first-out queue though any type of queue may be used to perform the described functionality. Each processing queue 140-140n may be associated with a particular processor 150-150n, such that each transaction 104 in a particular processing queue 140 may be processed in serial. In some embodiments, processing queues 140-140n may be concurrent such that put and get operations may be performed without locking.

Aggregator 146-146n represents any appropriate combination of hardware, memory, logic, and/or software suitable to perform the described functions. Aggregator 146 may be able to analyze transactions 104 stored in a particular processing queue 140 and determine if one or more transactions 104 should be combined into a single transaction 104, which creates efficiencies in system 100 by only having to process one transaction 104 and one memory write, instead of unnecessarily processing multiple transactions 104 and memory writes. In some embodiments, aggregator 146 may combine all transactions 104 modifying a particular target object 170 into a single transaction 104. In some embodiments, aggregator 146 may not combine multiple transactions 104 associated with the same object 170 if another intervening transaction is instructed to reset target object 170. For example, if one transaction 104 in a particular processing queue 140 increases the value associated with the number of hits for web service XYZ by 300 and another transaction 104 in the processing queue 140 increases the value associated with the number of hits for the same web service XYZ by 500, then aggregator 146 may create a new transaction increasing the value associated with the number of hits for web service XYZ by 800.

Processor 150-150n may represent and/or include any form of processing component, including general purpose computers, dedicated microprocessors, or other processing devices capable of processing electronic information. Examples of processor 150 include digital signal processors (DSPs), application-specific integrated circuits (ASICs), field-programmable gate arrays (FPGAs), and any other suitable specific or general purpose processors. After successfully processing transaction 104 and updating or modifying target object 170 in memory 160, processor 150 or another component may send an acknowledge message to transaction queue 128 to remove transaction 104 from transaction queue 128.

Memory 160 may comprise any collection and arrangement of volatile and/or non-volatile components suitable for storing data and objects 170. For example, memory 160 may comprise random access memory (RAM) devices, read only memory (ROM) devices, magnetic storage devices, shared memory, optical storage devices, and/or any other suitable data storage devices. In particular embodiments, memory 160 may represent, in part, computer-readable storage media on which computer instructions and/or logic are encoded. Although shown in FIG. 1 as a single component, memory 160 may represent any number of memory components within, local to, and/or accessible by processor 150. Although shown in FIG. 1 as internal to server 120, memory 160 may be external server 120. In some embodiments, memory 160 may include one or more databases, such that each database may have one or more tables, and each table may have one or more rows, and each row may have one or more values. Object 170 may be any type of data that can be modified, updated, stored, or reset according to transactions 104 processed by processors 150. In some embodiments, a targeted object 170 may refer to any value or data stored on a particular row in a database, such that all transactions 104 associated with updating or modifying a particular row in a database may be assigned to the same processing queue 140 and processor 150. Examples of objects 170 may include, but are not limited to, values (e.g., money, visits, dates, etc.), pointers, videos, images, web pages, etc.

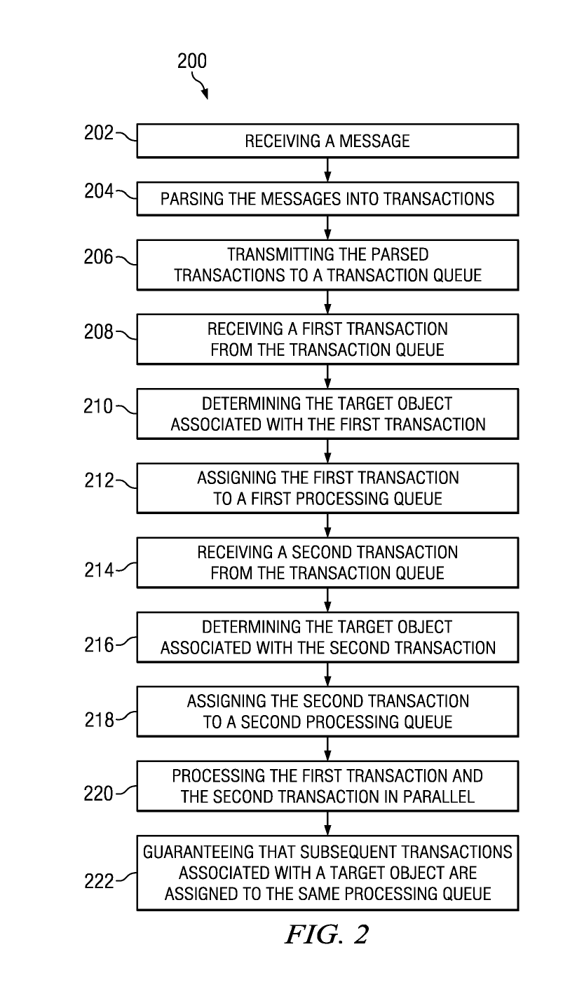

FIG. 2 is a flow diagram 200 illustrating a process for distributing a plurality of transactions for parallel processing, in accordance with the present disclosure. In the illustrated example, flow diagram 200 begins at step 202 where message parser 124 receives a message 102 from a remote server 110 on network 112 via a message queue 118. At step 204, message parser 124 may intelligently identify different sub-events or transactions 104 in message 102 based on any type of criteria, including, but not limited to properties associated with message 102, the type of instruction included in message 102, the type of message 102, the targeted object 170 to be updated or modified by an instruction, etc. At step 206, message parser 124 may transmit each parsed transaction 104 of message 102 to transaction queue 128, and communicate an acknowledge signal to message queue 118 to remove parsed message from message queue 118.

At step 208, transaction manager 132 may receive a first transaction 104 from transaction queue 128. At step 210, transaction manager 132 may intelligently determine an affinity associated with the first transaction 104 based on any type of criteria, including, but not limited to properties associated with the first transaction 104, the type of instruction included in the first transaction 104, the type of transaction 104, the target object 170 modified by the first transaction 104, etc. Thus, transaction manager 132 may be able to determine an affinity associated with the first transactions 104 that should be processed in serial by a particular processor 150, along with other transactions 104 having the same affinity (e.g., the transactions that modify the same target object). At step 212, transaction manager 132 may assign a first processing queue 140 and a first processor 150 to receive the first transaction 104 based on the affinity associated with the first transaction 104.

At step 214, transaction manager 132 may receive a second transaction 104 from transaction queue 128. At step 216, transaction manager 132 may intelligently determine that a different affinity is associated with the second transaction than was associated with the first transaction 104 based on any type of criteria, including, but not limited to properties associated with the second transaction 104, the type of instruction included in the second transaction 104, the type of transaction 104, the target object 170 modified by the second transaction 104, etc. Thus, transaction manager 132 may be able to determine an affinity associated with the second transactions 104 that should be processed in serial by a particular processor 150, along with other transactions 104 having the same affinity (e.g., the transactions that modify the same target object). At step 218, transaction manager 132 may assign a second processing queue 140 and a second processor 150 to receive the second transaction 104 based on the affinity associated with the second transaction.

At step 220, the first processor 150 may process the first transaction 104 that modifies or updates the first object 170 in parallel with the second processor 150 processing the second transaction 104 that modifies or updates the second object 170. At step 222, transaction manager 132 may ensure that subsequent transactions 104 modifying or updating the first object 170 are also assigned to the first processing queue 140 and first processor 150, and that subsequent transactions 104 modifying or updating the second object are also assigned to the second processing queue 140 and second processor 150. Thus, transaction manager 132 may guarantee that the first target object 170 is modified or updated safely and in the correct order and that the second target object 170 is modified or updated safely and in the correct order, while gaining the benefits of the first processor 150 and second processor 150 (and other processors) processing transactions 104 in parallel. Using the same thread or processor 150 to process transactions modifying the same target object 170 in serial greatly reduces the risks and errors that may occur when multiple threads or processors are processing transactions 104 modifying the same target object 170 in parallel.

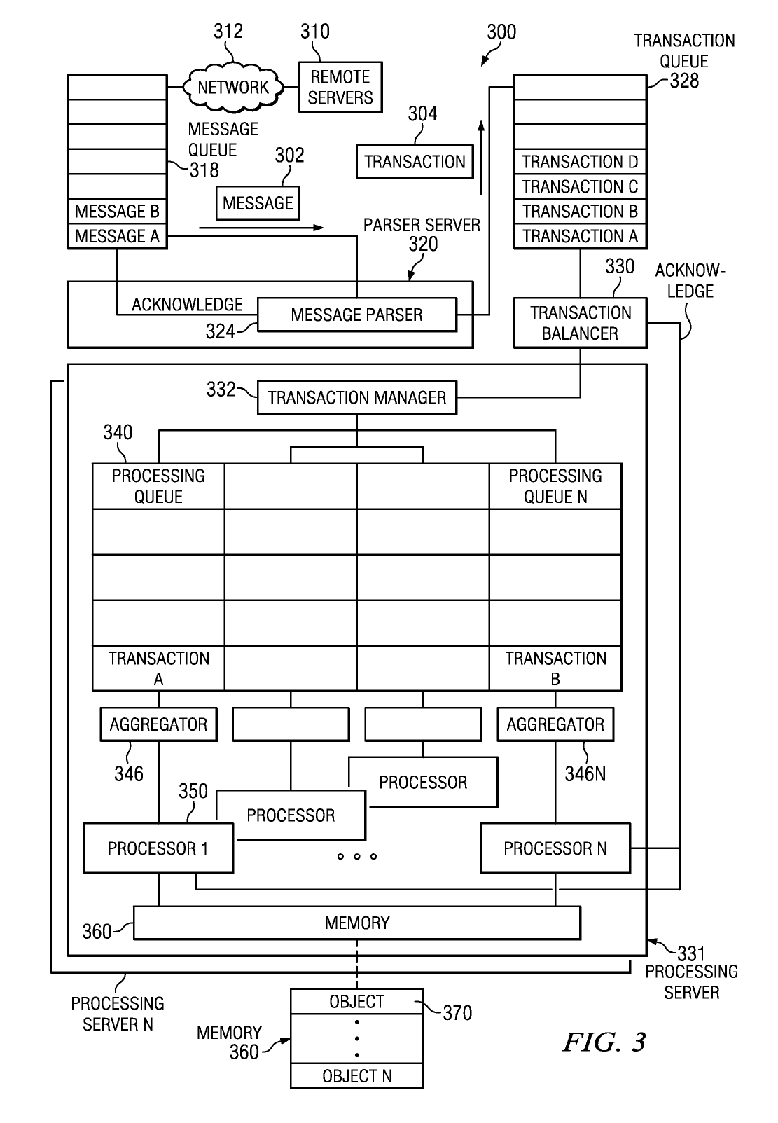

FIG. 3 is a schematic diagram illustrating another example system 300 distributing a plurality of transactions for parallel processing, in accordance with the present disclosure. According to the illustrated embodiment, system 300 may include a parser server 320 comprising a message queue 318, a message parser 324, and a transaction balancer 330. System 300 may also include one or more processing servers 331-331n, which each comprise a transaction manager 332, one or more processing queues 340-340n, one or more processors 350-350n, and a memory 360. Messages 302 may originate from remote servers 310 via network 312 and be received at message queue 318. Each message 302 may include one or more sub-events or transactions 304 that may be processed by one of the processors 350 to modify or update an object 370 stored in memory 360. System 300 may process multiple transactions 304 in parallel while ensuring that transactions 304, which are associated with modifying the same object 370, are processed in serial to ensure that each object 370 is modified in the proper order. Thus, system 300 gains the benefits of modifying multiple objects 370 in memory 360 simultaneously while eliminating the risks that an object 370 may be modified by a transaction 304 out of order. Further, transaction balancer 330 may intelligently distribute transactions 304 to particular processing servers 331 to create further efficiencies gained when processing transactions 304.

As used herein, messages 302 refer to any type of data that may be processed to modify, update, or store one or more values or objects 370 in memory 360. Messages 302 may be communicated in any form. Messages 302 may include one or more sub-events or transactions 304. Each transaction 304 refers to any type of data that may be processed to modify, update, or store a value or object 370 in memory 360. Transactions 304 may include software, computer instructions, and/or logic that may be processed by processors 350. For example, an electronic message 302 to transfer money from a first account to a second account may include a first transaction 304 to subtract the money from the first account and a second transaction 304 to add the money to the second account.

Remote servers 310 may represent a general or special-purpose computer capable of performing the described operations. For example, remote servers 310 may include, but are not limited to, mobile devices; cell phones; laptop computers; desktop computers; end user devices; video monitors; cameras; personal digital assistants (PDAs); or any other communication hardware, software, and/or encoded logic that supports the communication of messages 302, transactions 304, texts, or other suitable forms of data. Remote servers 310 may include any appropriate combination of hardware, software, memory, and/or encoded logic suitable to perform the described functionality. System 300 may comprise any appropriate number and type of remote servers 310. Although the embodiment illustrated in FIG. 1 illustrates that remote servers 310 may be external to parser server 320, remote servers 110 may be integral or directly connected to parser server 320.

Network 312 may represent any form of communication network supporting circuit-switched, packet-based, and/or any other suitable type of communications between remote servers 310, parser server 320, processing servers 331, and any other elements illustrated in FIG. 3. Network 312 may additionally include any other nodes of system 300 capable of transmitting and/or receiving information over a communication network. Although shown in FIG. 3 as a single element, network 312 may represent one or more separate networks (including all or parts of various different networks) that are separated and serve different respective elements illustrated in FIG. 3. Network 312 may include routers, hubs, switches, firewalls, content switches, gateways, call controllers, and/or any other suitable components in any suitable form or arrangement. Network 312 may include, in whole or in part, one or more secured and/or encrypted Virtual Private Networks (VPNs) operable to couple one or more network elements together by operating or communicating over elements of a public or external communication network. In general, network 312 may comprise any combination of public or private communication equipment such as elements of the public switched telephone network (PSTN), a global computer network such as the Internet, a local area network (LAN), a wide area network (WAN), or other appropriate communication equipment. In some embodiments, application 310 may exist on the same machine, which may obviate the need for any network communications.

Message queue 318 may be any type of storage or buffer implementation to receive messages 302 from remote servers 310. In some embodiments, message queue 318 may implement a first-in-first-out queue though any type of queue may be used to perform the described functionality. Although the embodiment illustrated in FIG. 3 illustrates message queue 318 may be external to parser server 320, message queue 318 may be stored on parser server 320.

Parser server 320 represents any appropriate combination of hardware, memory, logic, and/or software suitable to perform the described functions. For example, parser server 320 may be any suitable computing device comprising a processor and a memory. Parser server 320 may comprise one or more machines, workstations, laptops, blade servers, server farms, and/or stand-alone servers. Parser server 320 may be operable to communicate with any node or component in system 300 in any suitable manner.

Message parser 324 represents any appropriate combination of hardware, memory, logic, and/or software suitable to perform the described functions. Message parser 324 may receive message 302 via message queue 318 and parse message 302 into one or more transactions 304. Message parser 324 may intelligently identify different sub-events or transactions 304 in message 302 based on any type of criteria, including, but not limited to properties associated with message 302, the type of instruction included in message 302, the type of message 302, the object 370 modified by an instruction, etc. Message parser 324 may transmit each parsed transaction 304 of message 302 to transaction queue 328, and communicate an acknowledge signal to message queue 318 to remove the parsed message 302 from message queue 318.

Transaction queue 328 may be any type of storage or buffer implementation to receive transactions 304 from message parser 324. In some embodiments, transaction queue 328 may implement a first-in-first-out queue though any type of queue may be used to perform the described functionality. Although the embodiment illustrated in FIG. 3 illustrates that transaction queue 128 may be external to parser server 320, transaction queue 328 may be stored on server 320.

Transaction balancer 330 represents any appropriate combination of hardware, memory, logic, and/or software suitable to perform the described functions. Transaction balancer 330 may receive one or more transactions 304 via transaction queue 328. Transaction balancer 330 may intelligently identify which processing server 331 should receive each particular transaction 304 based on any type of criteria, including, but not limited to properties associated with transaction 304, the type of instruction included in the transaction 304, the type of transaction 304, the target object 370 modified by transaction 304, etc. Thus, transaction balancer 330 may be able to determine an affinity for certain transactions 304 that should be processed by the same processing server 331. In some embodiments, transaction balancer 330 may ensure that a transaction 304 and subsequent transactions 304 that modify or update the same target object 370 or share the same affinity are assigned to the same processing server, which may create additional efficiencies when processing transactions 304. For example, transaction balancer 330 may assign all transactions associated with the same database, or the same table of a database, or the same row of a table to a particular processing server 332, which may create additional efficiencies. In another example, transaction balancer 330 may assign all transactions associated with a particular geography to a particular processing server 332, which may also create additional efficiencies. For example, if rules associated with banking accounts in California need to be updated before processing any further transactions on banking accounts in California, it is much more efficient and simpler to block all processing queues in the processing server 331 associated with banking accounts in California, which allows for all of the other transactions 104 on the other processing servers 331 to be processed as normal without having to stop processing transactions for a particular software update or maintenance issue. Although the embodiment illustrated in FIG. 3 illustrates that transaction balancer 330 may be external to parser server 320, transaction balancer 330 may be stored on parser server 320.

Processing servers 331-331n represent any appropriate combination of hardware, memory, logic, and/or software suitable to perform the described functions. For example, each processing server 331 may be any suitable computing device comprising a processor and a memory. Processing servers 331 may comprise one or more machines, workstations, laptops, blade servers, server farms, and/or stand-alone servers. Processing servers 331 may be operable to communicate with any node or component in system 300 in any suitable manner.

Transaction manager 332 represents any appropriate combination of hardware, memory, logic, and/or software suitable to perform the described functions. Transaction manager 332 may receive one or more transactions 304 via transaction balancer 330. Transaction manager 332 may intelligently identify which processing queue 340 and processor 350 should receive each particular transaction 304 based on any type of criteria, including, but not limited to properties associated with transaction 304, the type of instruction included in the transaction 304, the type of transaction 304, the target object 370 modified by transaction 304, etc. Thus, transaction manager 332 may be able to determine an affinity for certain transactions 304 that should be processed in serial by a particular processor 350. In some embodiments, transaction manager 332 may ensure that a transaction 304 and subsequent transactions 304 that modify or update the same target object 370 are assigned to the same processing queue 340 associated with the same processor 350, which guarantees that the target object 370 be modified or updated in the correct order, while other processors 350 may process other transactions 304 in parallel that modify or update a different target object 370. In some embodiments, all transactions 304 associated with a particular row in a database may be assigned to the same processing queue 340. In some embodiments, transaction manager 332 may determine that all computations for one or more transactions 304 be assigned to a particular processing queue 340 and processed by its respective processor 350 while all other processing queues 340 and processors 350 are blocked from processing any other transactions 304. In some embodiments, transaction manager 332 may determine to use one or more processing queues 340 and processors 350 in a synchronized order. In some embodiments, transaction manager 332 may instruct all transactions 304 within processing queues 340 to be processed and to block all subsequent transactions 304 from being placed in processing queues 340 so that maintenance may be performed.

Processing queues 340-340n may be any type of storage or buffer implementation to receive transactions 304 from transaction manager 332. In some embodiments, processing queue 340 may implement a first-in-first-out queue though any type of queue may be used to perform the described functionality. Each processing queue 340-340n may be associated with a particular processor 350-350n, such that each transaction 304 in a particular processing queue 340 may be processed in serial. In some embodiments, processing queues 340-340n may be concurrent such that put and get operations may be performed without locking.

Aggregators 346-346n represents any appropriate combination of hardware, memory, logic, and/or software suitable to perform the described functions. Aggregator 346 may be able to analyze transactions 304 stored in a particular processing queue 340 and determine if one or more transactions 304 should be combined into a single transaction 304, which creates efficiencies in system 300 by only having to process one transaction 304 and one memory write, instead of unnecessarily processing multiple transactions 304 and memory writes. In some embodiments, aggregator 346 may combine all transactions 304 modifying a particular target object 370 into a single transaction 304. In some embodiments, aggregator 346 may not combine multiple transactions 304 associated with the same object 370 if another intervening transaction is instructed to reset target object 370. For example, if one transaction 304 in a particular processing queue 340 increases the value associated with the number of hits for web service XYZ by 300 and another transaction 304 in the processing queue 340 increases the value associated with the number of hits for the same web service XYZ by 500, then aggregator 346 may create a new transaction increasing the value associated with the number of hits for web service XYZ by 800.

Processor 350-350n may represent and/or include any form of processing component, including general purpose computers, dedicated microprocessors, or other processing devices capable of processing electronic information. Examples of processor 350 include digital signal processors (DSPs), application-specific integrated circuits (ASICs), field-programmable gate arrays (FPGAs), and any other suitable specific or general purpose processors. After successfully processing transaction 304 and updating or modifying target object 370 in memory 360, processor 350 or another component may send an acknowledge message to transaction queue 328 to remove transaction 304 from transaction queue 328 or transaction balancer 330.

Memory 360 may comprise any collection and arrangement of volatile and/or non-volatile components suitable for storing data and objects 370. For example, memory 360 may comprise random access memory (RAM) devices, read only memory (ROM) devices, magnetic storage devices, shared memory, optical storage devices, and/or any other suitable data storage devices. In particular embodiments, memory 360 may represent, in part, computer-readable storage media on which computer instructions and/or logic are encoded. Although shown in FIG. 3 as a single component, memory 360 may represent any number of memory components within, local to, and/or accessible by processor 350. Although shown in FIG. 3 as internal to one or more processing servers 331, memory 360 may be external to one or more processing servers 331. In some embodiments, memory 360 may only be modified by the particular processing server 331 having the memory 360. In some embodiments, memory 360 may be accessible and modified by one or more of the processing servers 331. In some embodiments, memory 360 may include one or more databases, such that each database may have one or more tables, and each table may have one or more rows, and each row may have one or more values. Object 370 may be any type of data that can be modified, updated, stored, or reset according to transactions 304 processed by processors 350. In some embodiments, a targeted object 370 may refer to any value or data stored on a particular row in a database, such that all transactions 304 associated with updating or modifying a particular row in a database may be assigned to the same processing queue 340 and processor 350. Examples of objects 370 may include, but are not limited to, values (e.g., money, visits, dates, etc.), pointers, videos, images, web pages, etc.

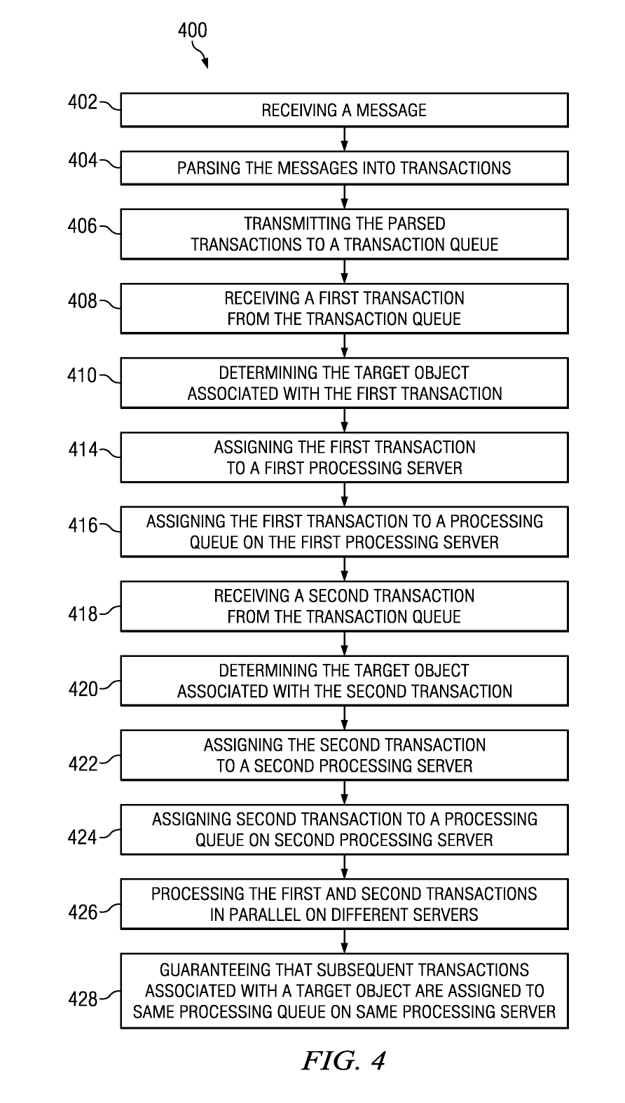

FIG. 4 is a flow diagram 400 illustrating another process for distributing a plurality of transactions for parallel processing, in accordance with the present disclosure. In the illustrated example, flow diagram 400 begins at step 402 where message parser 324 receives a message 302 from a remote server 310 on network 312 via a message queue 318. At step 404, message parser 324 may intelligently identify different sub-events or transactions 304 in message 302 based on any type of criteria, including, but not limited to properties associated with message 302, the type of instruction included in message 302, the type of message 302, the targeted object 370 to be updated or modified by an instruction, etc. At step 306, message parser 324 may transmit each parsed transaction 304 of message 302 to transaction queue 328, and communicate an acknowledge signal to message queue 318 to remove parsed message from message queue 318.

At step 408, transaction manager 332 may receive a first transaction 304 from transaction queue 328.

At step 410, transaction balancer 330 may intelligently determine an affinity associated with the first transaction 304 based on any type of criteria, including, but not limited to properties associated with the first transaction 304, the type of instruction included in the first transaction 304, the type of transaction 304, the target object 370 modified by the first transaction 304, etc. At step 414, transaction balancer 330 may be able to determine an affinity associated with the first transaction 304 that should be assigned to a first processing server 331, along with other transactions 304 having the same affinity (e.g., the transactions modify an object within the same table or within the same geographic region).

At step 416, transaction manager 332 may intelligently determine an affinity associated with the first transaction 304 based on any type of criteria, including, but not limited to properties associated with the first transaction 304, the type of instruction included in the first transaction 304, the type of transaction 304, the target object 370 modified by the first transaction 304, etc. Thus, transaction manager 332 may be able to determine an affinity associated with the first transactions 304 that should be processed in serial by a particular processor 150, along with other transactions 304 having the same affinity (e.g., the transactions that modify the same target object). Transaction manager 332 may assign a first processing queue 340 and a first processor 350 on first processing server 31 to receive the first transaction 104 based on the affinity associated with the first transaction 304.

At step 418, transaction balancer 330 may receive a second transaction 304 from transaction queue 328.

At step 420, transaction balancer 330 may intelligently determine an affinity associated with the second transaction 304 based on any type of criteria, including, but not limited to properties associated with the second transaction 304, the type of instruction included in the second transaction 304, the type of transaction 304, the target object 370 modified by the second transaction 304, etc. At step 422, transaction balancer 330 may be able to determine an affinity associated with the second transaction 304 that should be assigned to a second processing server 331, along with other transactions 304 having the same affinity (e.g., the transactions modify an object within the same table or within the same geographic region).

At step 424, transaction manager 332 may intelligently determine an affinity associated with the second transaction 304 based on any type of criteria, including, but not limited to properties associated with the second transaction 304, the type of instruction included in the second transaction 304, the type of transaction 304, the target object 370 modified by the second transaction 304, etc. Thus, transaction manager 332 may be able to determine an affinity associated with the second transactions 304 that should be processed in serial by a particular processor 150, along with other transactions 304 having the same affinity (e.g., the transactions that modify the same target object). Transaction manager 332 may assign a first processing queue 340 and a first processor 350 on second processing server 331 to receive the first transaction 104 based on the affinity associated with the second transaction 304.

At step 426, the first processing server 331 may process the first transaction 304 that modifies or updates the first object 370 in parallel with the second processing server 331 processing the second transaction 304 that modifies or updates the second object 370. At step 428, transaction balancer 330 and transaction manager 332 may ensure that subsequent transactions 304 modifying or updating the first object 370 are also assigned to the first processing queue 340 and first processor 350 of first processing server 331, and that subsequent transactions 304 modifying or updating the second object are also assigned to the first processing queue 340 and first processor 350 of second processing server 331. Thus, transaction balancer 330 and transaction manager 332 may guarantee that the first target object 370 is modified or updated safely and in the correct order and that the second target object 370 is modified or updated safely and in the correct order, while gaining the benefits of the multiple processors 350 of multiple processing servers 331 processing transactions 304 in parallel. Using the same thread or processor 350 to process transactions modifying the same target object 370 in serial greatly reduces the risks and errors that may occur when multiple threads or processors are processing transactions 304 modifying the same target object 370 in parallel.

While various embodiments have been described above, it should be understood that they have been presented by way of example only, and not limitation. Thus, the breadth and scope of a preferred embodiment should not be limited by any of the above described exemplary embodiments, but should be defined only in accordance with the claims and their equivalents for any patent that issues claiming priority from the present provisional patent application.

For example, as referred to herein, a machine or engine may be a virtual machine, computer, node, instance, host, or machine in a networked computing environment. Also as referred to herein, a networked computing environment is a collection of machines connected by communication channels that facilitate communications between machines and allow for machines to share resources. Network may also refer to a communication medium between processes on the same machine. Also as referred to herein, a server is a machine deployed to execute a program operating as a socket listener and may include software instances.

Resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof.

A networked computing environment may include, but is not limited to, computing grid systems, distributed computing environments, cloud computing environment, etc. Such networked computing environments include hardware and software infrastructures configured to form a virtual organization comprised of multiple resources which may be in geographically disperse locations.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context. Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A system for distributing a plurality of transactions for parallel processing, comprising:
a plurality of processors, wherein the processors can process a plurality of transactions in parallel;
a message parser operable to:
receive a message, wherein the message comprises a plurality of transactions that can be processed by the processors, wherein each transaction comprises information associated with a target object, wherein the target object is stored in a memory;
parse the messages into the plurality of transactions; and
transmit the parsed transactions to a transaction queue; and
the transaction manager operable to:
receive a transaction from the transaction queue;
determine the target object associated with the transaction; and
assign the transaction to a particular processing queue based on the target object; and
guarantee that subsequent transactions associated with the target object are assigned to the same processing queue and the same processor, which guarantees that the target object will be modified in correct sequence, wherein the transaction associated with the target object is processed in parallel with other transactions associated with different target objects.

2. The system of claim 1, wherein the transaction manager is further operable to:
receive a subsequent transaction from the transaction queue;
determine that a second target object is associated with the subsequent transaction;
assign the subsequent transaction to a second processing queue based on the second target object being different than the first target object; and
guarantee that additional subsequent transactions associated with the second target object are assigned to the second processing queue and the second processor, which guarantees that the second target object will be modified in correct sequence, wherein the transaction associated with the second object is processed by the second processor in parallel with the transaction associated with the target object processed by the first processor.

3. The system of claim 1, wherein the message is received from an external source.

4. The system of claim 1, wherein the target object is any object associated with a particular row in a database.

5. The system of claim 1, wherein the processor is a computer processor unit.

6. The system of claim 1, wherein the message is associated with a financial transaction.

7. The system of claim 1, wherein the transaction queue is first-in-first-out.

8. The system of claim 1, wherein the processing queue is first-in-first-out.

9. The system of claim 1, wherein the transaction manager is further operable to guarantee that the target object is not being processed by two different processors at the same time.

10. A method for distributing a plurality of transactions for parallel processing, comprising:
receiving a message, wherein the message comprises a plurality of transactions, wherein each transaction comprises information associated with a target object, wherein the target object is stored in a memory;
parsing the messages, by a message parser, into the plurality of transactions;
transmitting the parsed transactions to a transaction queue;
receiving, by a transaction manager, a transaction from the transaction queue;
determining the target object associated with the transaction;
assigning the transaction to a particular processing queue based on the target object, wherein the particular processing queue is associated with a particular processor; and
guaranteeing that subsequent transactions associated with the target object are assigned to the same processing queue and the same processor, which guarantees that the target object will be modified in correct sequence, wherein the transaction associated with the target object is processed in parallel with other transactions associated with different target objects.

11. The method of claim 10, wherein the method further comprises:
receiving a subsequent transaction from the transaction queue;
determining that a second target object is associated with the subsequent transaction;
assigning the subsequent transaction to a second processing queue based on the second target object being different than the first target object; and
guaranteeing that additional subsequent transactions associated with the second target object are assigned to the second processing queue and the second processor, which guarantees that the second target object will be modified in correct sequence, wherein the transaction associated with the second object is processed by the second processor in parallel with the transaction associated with the target object processed by the first processor.

12. The method of claim 10, wherein the message is received from an external source.

13. The method of claim 10, wherein the target object is any object associated with a particular row in a database.

14. The method of claim 10, wherein the processor is a computer processor unit.

15. The method of claim 10, wherein the message is associated with a financial transaction.

16. The method of claim 10, wherein the transaction queue is first-in-first-out.

17. The method of claim 10, wherein the processing queue is first-in-first-out.

18. Logic for distributing a plurality of transactions for parallel processing, the logic being embodied in a computer-readable medium and when executed operable to:
receive a message, wherein the message comprises a plurality of transactions, wherein each transaction comprises information associated with a target object, wherein the target object is stored in a memory;
parse the messages, by a message parser, into the plurality of transactions;
transmit the parsed transactions to a transaction queue;
receive, by a transaction manager, a transaction from the transaction queue;
determine the target object associated with the transaction;
assign the transaction to a particular processing queue based on the target object, wherein the particular processing queue is associated with a particular processor; and
guarantee that subsequent transactions associated with the target object are assigned to the same processing queue and the same processor, which guarantees that the target object will be modified in correct sequence, wherein the transaction associated with the target object is processed in parallel with other transactions associated with different target objects.

19. The logic of claim 18, wherein the logic is further operable to:
receive a subsequent transaction from the transaction queue;
determine that a second target object is associated with the subsequent transaction;
assign the subsequent transaction to a second processing queue based on the second target object being different than the first target object; and
guarantee that additional subsequent transactions associated with the second target object are assigned to the second processing queue and the second processor, which guarantees that the second target object will be modified in correct sequence, wherein the transaction associated with the second object is processed by the second processor in parallel with the transaction associated with the target object processed by the first processor.

20. The logic of claim 18, wherein the message is received from an external source.

21. The logic of claim 18, wherein the target object is any object associated with a particular row in a database.

22. The logic of claim 18, wherein the processor is a computer processor unit.

23. The logic of claim 18, wherein the message is associated with a financial transaction.

24. The logic of claim 18, wherein the transaction queue is first-in-first-out.

25. The logic of claim 18, wherein the processing queue is first-in-first-out.
